(19) United States
(12) Patent Application Publication
(10) Pub. No.: US 2020/0349511 A1
(43) Pub. Date: Nov. 5, 2020

(54) SYSTEMS AND METHODS OF LOCAL AREA OPTIMIZATION FOR ROUTING AND DELIVERY OF ITEMS

(71) Applicant: United States Postal Service, Washington, DC (US)

(72) Inventors: Kristin Seaver, Narragansett, RI (US); Stephen M. Dearing, Herndon, VA (US)

(21) Appl. No.: 16/861,958

(22) Filed: Apr. 29, 2020

Related U.S. Application Data
(60) Provisional application No. 62/843,387, filed on May 4, 2019.
(60) Provisional application No. 62/867,113, filed on Jun. 26, 2019.

(51) Int. Cl. G06Q 10/08; G06Q 30/02; G06Q 10/04; G06Q 10/06; G06K 7/14

(52) U.S. Cl. CPC G06Q 10/08355; G06Q 30/0205; G06Q 10/0836; G06K 7/1413; G06Q 10/06315; G06Q 10/06312; G06Q 10/047

(57) ABSTRACT

Systems and methods for delivering items within a local area of commerce utilizing resources from a distribution network. A distribution network within the area of commerce can be utilized to provide transportation of items and logistic support utilizing a variety of resources within the area of commerce. A server can provide to merchants requesting item delivery locations for item drops and pick-ups, and can assign delivery resources to meet existing and future service class requirements.

### CROSS REFERENCE TO RELATED APPLICATIONS

This application claims priority to and the benefit of Provisional Applications Nos. 62/843,387 filed May 4, 2019 and 62/867,113, filed Jun. 26, 2019 in the U.S. Patent and Trademark Office, the entire contents of all of which are incorporated herein by reference.

### BACKGROUND

The present disclosure relates to methods of utilizing local area resources for efficient and timely delivery of items.

### BRIEF DESCRIPTION OF THE DRAWINGS

The foregoing and other features of the present disclosure will become more fully apparent from the following description and appended claims, taken in conjunction with the accompanying drawings. Understanding that these drawings depict only several embodiments in accordance with the disclosure and are not to be considered limiting of its scope, the disclosure will be described with additional specificity and detail through use of the accompanying drawings.

FIG. 1 is a block diagram depicting an exemplary computer system for managing an area of commerce.

FIG. 2 depicts an exemplary method for delivery of an item.

FIG. 3 is a flow chart depicting an exemplary a method for delivery of a first item.

FIG. 4 is a flow chart depicting an exemplary method for delivery of an item.

FIG. 5 is a map depicting exemplary routes and determinations for distribution of items.

FIG. 6 is a map depicting exemplary routes and determinations for distribution of items.

FIG. 7 is a block diagram illustrating an exemplary hardware configuration for a delivery system.

FIG. 8 depicts a method of delivering items from a commercial merchant to a business or other merchant.

### DETAILED DESCRIPTION

Reference will now be made in detail to the present embodiments, examples of which are illustrated in the accompanying drawings. Wherever possible, the same reference numbers will be used throughout the drawings to refer to the same or like parts.

A distribution network can distribute and/or deliver items to a plurality of geographic areas, which can be local and/or can be nationwide. Geographic areas can be divided into areas of commerce or commercial spheres of influence. This can be based, for example, on population, on a number of delivery points, and/or on resources available in an area. The resources can be customer and distribution network resources, and can include vehicles, rolling stock, carriers, employees, buildings, computers and computing systems, networks, services, sub-contractors, and other quantities or services that are used in conducting commerce in an area. The population information and resource information can be used to generate a plurality of areas of commerce within a geographic area, such as a country, a state, a county, etc. The boundaries of the areas of commerce and the resource information for each area can be provided to distribution networks and to customers, which can include shippers, distributors, merchants, retailers, or any other group that may wish to deliver one item or bulk items to a geographic area.

In some embodiments, all the resources, senders, shippers, recipients, merchants, and other entities within a geographic area can be considered for inclusion into an area of commerce. An area of commerce can be determined based on a variety of factors, including, for example, the number of delivery points, the volume of items transported within the area, the number of merchants, sellers, retailers, etc., the density of population, the number of resources, and other factors.

The resources can also include a number of distribution network facilities such as postal facilities, vehicles, rolling stock, carriers, processing facilities, employees, etc. are determined for the geographic area. Typical item volumes, including historical volumes for times of the year such as holiday surges are assigned to the geographic area. For each geographic area, the distribution network assets will be identified. In the example of the United States Postal Service (USPS), each processing center, post office, vehicle, carrier, employee, and the capacity for each, will be identified.

The USPS has an extensive physical footprint, which includes over 217,000 carrier routes, over 31,000 post offices and 285 processing centers, 134 million delivery points serviced daily, over 230,000 vehicles, and billions of pieces of carrier data, including carrier GPS breadcrumb data each day. These extensive resources can be divided into geographic areas, called areas of commerce. Areas having greater population density, can have smaller service areas for same day delivery. For example, an extent of an area of commerce in the New York metropolitan area may be set to 1 mile, whereas an extent of an area of commerce for a city in Iowa may be set to 20, 30, 50 miles or greater. For example, an area of commerce in Manhattan, N.Y. can have a 1-mile radius, include 60 ZIP codes, 197,545 delivery points, and be serviced by 685 carriers, 403 vehicles, and 1,086 employees. An area of commerce in Chadwick, Iowa can have a 30 mile radius, include 63 ZIP codes, have 92,277 delivery points serviced by 270 carriers, 192 vehicles, and 405 employees.

In addition to resources of the distribution network, merchant and commercial resources can be included in the area of commerce. This can include the presence of merchant facilities, such as stores, warehouses, distribution centers, and the like. The resources of the distribution network and the commercial entities can be organized into areas of commerce. The areas of commerce need not, and may not necessarily correspond to existing divisions of the geography of the country. For example, a local area of commerce can include more than one ZIP code or area code, can cross ZIP code or area code boundaries. Local areas of commerce may not follow political or governmental boundaries. The local areas of commerce can be established according to the availability and type or resources, population, population density, transportation corridors, and the like. In some embodiments, a geographic area can be divided into a plurality of local areas of commerce. Some local areas of commerce may overlap, at least in part, with other local areas of commerce, and the resources of the overlapping portions can be allocated to both the areas of commerce.

To efficiently utilize the resources of the distribution network and commercial entities, such as merchants, transportation entities, and the like, item senders, item receivers, and the distribution network can use a set of APIs to allow the exchange of information between all interested parties and computer systems. As an example, the USPS or other entity can manage a system where inventory systems, locations, vehicles, carriers, tracking, pricing, payment, and other desired attributes can be combined or interchanged through an API. This can enable item senders, shippers, retailers, etc., which can include, for example, merchants who send large volumes of items into any given area of commerce or who send items locally within an area of commerce, to communicate cost preferences, item attributes, cost expectations, delivery preferences, classes of service, pick-up and delivery time requirements, coordinate shipping and logistics, and the like, with the area of commerce. In turn, the system can utilize APIs to receive delivery preferences and to provide real-time tracking updates to receivers.

The system receives all this information from senders and receivers, and allocates the resources within the area of commerce in order to meet the requirements of the senders and the receivers, and other parties or entities.

In one example, a large volume sender, such as CVS or Target can interface via an API, or other similar system, to provide information regarding an intended large shipment to a particular area of commerce. The system can use the request to determine whether a requested service class can be met, or can reallocate resources within the area of commerce in order to meet the service class. The system can also provide additional service options to CVS or Target based on the availability of resources, set pricing, provide discounts and other offers, set timing windows for various service classes, drop and pickup times, and the like, when senders, the distribution network, and receivers are interconnected. The system can provide information to receivers, which can be local CVS locations or Target stores, or to individual recipients based on the information from the senders. In some embodiments, the USPS can manage, maintain, run, support, generate, provide, or otherwise be involved with the system.

Entities that will ship a large number of packages to a certain area can access reports on availability and capacity of the resources within an area of commerce in order to understand potential service classes, expected delivery dates, same day delivery, etc. Access to this information can be provided via an API which allows an entity to determine whether the delivery resources for a geographic area to which the entity will ship items has the capacity to meet a required service standard, such as same-day delivery. If a shipper desires to ship to or within a particular geographic area, the distribution network can determine whether the resources such as vehicles, carriers, employees, and rolling stock, containers, and the like are sufficient, and can reallocated delivery resources within or between geographical areas to meet upcoming demand.

Real-time information can be provided to shippers regarding ability of the distribution network to meet service standards, shipper requests, such as same day delivery, next day delivery, and the like. The term “real-time” may mean that data is available to a user, either internal or external, approximately at the time that it is available or generated; for example, within from 0.01 to 20 seconds after the data is generated, such as 5 seconds, 2 seconds, 1 second, 0.5 second, or 0.1 second. The term “near real-time” may mean that the data is available shortly after it is available or generated, such as when a piece of equipment stores scan information for a time prior to making the information available. For example, a camera or scanner on item processing equipment may batch images or scans for a specified period, such as after a set number of scans, or after an elapsed time, such as every second, every 30 seconds, every minute, every 15 minutes, or every hour.

A distribution network may comprise multiple levels. For example, a distribution network may comprise regional distribution facilities, hubs, and unit delivery facilities, or any other desired level. For example, a nationwide distribution network may comprise one or more regional distribution facilities having a defined coverage area (such as a geographic area), designated to receive items from intake facilities within the defined coverage area, or from other regional distribution facilities. The regional distribution facility can sort items for delivery to another regional distribution facility, or to a hub level facility within the regional distributional facility's coverage area. A regional distribution facility can have one or more hub level facilities within its defined coverage area. A hub level facility can be affiliated with a few or many unit delivery facilities, and can sort and deliver items to the unit delivery facilities with which it is associated. In the case of the United States Postal Service, the unit delivery facility may be associated with a ZIP Code. The unit delivery facility receives items from local senders, and from hub level facilities or regional distribution facilities. The unit delivery facility also sorts and stages the items intended for delivery to destinations within the unit delivery facility's coverage area.

In some embodiments, a distribution network, such as USPS, or other distributor, tracks each item throughout the distribution process. In some embodiments, for real-time tracking of items in a distribution network, items can have a unique identifier, such as a computer-readable code. In some embodiments, the computer readable code may be a barcode, an RFID tag, a QR code, an alphanumeric code, or any other desirable computer readable code, which uniquely identifies the item and/or encodes information relating to the item. Each computer-readable code may be scanned by processing equipment, carriers with mobile scanners, personnel in the distribution network facilities, transportation providers, or by other entities within the distribution chain. Scan information, which can include the computer readable code, is transmitted to and stored in a central repository.

In some embodiments, such as when an item is to be picked up and delivered in the same day, or without passing through a distribution network facility, the item may not have a unique computer readable code thereon. The item can be logically tracked based on pick-up information, carrier location, delivery confirmation, and the like. The distribution network and/or a merchant can provide a tracking code to a recipient or to a customer in order to have access to the tracking information for the item.

In some embodiments, the customer wishing to ship an item can provide a code for tracking to the recipient. The code can be associated with the item within an area of commerce system via the API. In some embodiments, the code can be assigned by the API. The system and the sender or shipper can associate the code with the item and any tracking information. The code provided can be a code that is simple for a recipient to remember and input to a tracking application. The tracking application can be a user interface provided by the distribution network and/or the merchant. The code can be a 5, 6, 7, 8-digit code, or some other code that is easy to remember or is not too long.

In some embodiments, the tracking options offered by the system can be dependent on service level. A same day item will not have the same number of tracking events, as it will likely pass through fewer facilities and/or be handled by fewer resources. A same day item may have a real-time tracking option, whereas a 2-day service class may not offer real time tracking.

The present disclosure provides the ability for a customer to see resource availability for an entire area of commerce, provides the ability to ship items to meet a particular service class or delivery guarantee, and for the distribution network to reallocate delivery resources as needed to meet customer requests. In some embodiments, customers send information to a shipping organization (e.g., the USPS) to create an order for a new shipment. A customer may be an individual, a group of individuals, a business, or another type of entity that utilizes the shipping organization to deliver packages. A customer can also be a recipient of an item. A delivery provider may receive one or more shipped objects from the customer. As used herein, the term item can refer to a package, parcel, container, mailpiece, letter, flat, product, good, article, and the like. The delivery provider may dispatch the item from the origin location toward the package's designated destination. The time and route travelled by the package from the package's origin to destination can be complied as route data. The scheduling system may analyze data associated with a newly created shipment, to simulate a journey that the package will travel, and predict any possible problems to warn the customer. In some embodiments, the delivery provider may transfer the package to other entities for some, or all, of a package's journey.

Sending customers, such as merchants, retailers, or individuals returning items, may have different sending activities. A large nation-wide or regional merchant may wish to deliver large volumes of items to local merchant stores, franchises, etc. Some sending customers may be local or regional businesses who use the distribution network to send an item to a recipient, such as when the recipient orders an item online, via e-commerce, etc.

The large, nation-wide or regional merchant may desire to send deliveries of inventory, goods, supplies, etc. to merchant locations, such as stored or retail outlets, to a geographic area. The distribution can identify a local area of commerce covering one or more of the locations to which the merchant wishes to send items, and can provide this information to the nation-wide merchant. The nation-wide merchant can select the stores to which the items should be delivered within the area of commerce. The distribution network can identify a drop location for the large volume of items intended for a variety of different locations. The drop location can be a distribution network facility, such as a postal facility, a large processing plant, a rented building, or other location designated by the distribution network. The drop location can be determined by the distribution network based on the information provided by the merchant. For example, the distribution system can identify which area or areas of commerce exist within the geographic area, and can instruct the merchant to drop the items at a facility in one or more areas of commerce based on the intended distribution of the items.

The distribution network also determines how to allocate resources for delivering the items dropped by the merchants, including how to distribute the items within the area of commerce based on the intended recipients, service classes, special handling instructions, etc. For example, the distribution network determines how many vehicles, carriers, or other resources are needed to efficiently, effectively, and timely deliver the items to the intended locations. A scheduler may be implemented to determine how to schedule resources within the area of commerce to meet the service class requirements of the merchant's drop, and to meet the other requirements of the distribution networks other deliveries.

In some embodiments, a distribution facility may have more than one dispatch time, for example, a morning dispatch time and an afternoon dispatch time. If an item is at a facility before the morning dispatch time, it can be provided to a carrier or other resource as that resource leaves the facility in the morning, and can be delivered. If an item is not at the facility by the morning dispatch time, but arrives before the afternoon dispatch, then the item can be delivered via using an afternoon resource or a resource which is dedicated to delivering items at the afternoon dispatch. The afternoon dispatch can be accomplished using a dynamic routing tool to allocate resources and determine routes.

In some embodiments, the first dispatch can be a morning dispatch, and the second dispatch can be an on-demand dispatch. The resource delivering items for the second dispatch can deliver items directly to delivery points, or can meet other resources to hand-off the items to be delivered. The second dispatch can be dispatched following a large drop of items in a day. In some embodiments, the second dispatch time can be made available to merchants via an API or other similar means, so merchants can plan to drop items at a facility in time for the second dispatch. A scheduler can be utilized to set the time of the second dispatch, can be used to identify which items are prioritized for the second dispatch in the case of limited resources or time, or can be used to identify which vehicles are considered for picking up and/or delivering items form the second dispatch.

In some embodiments, a shipper can be a small or local retailer, or an individual seller, which sends items from a retail location directly to a recipient. In some embodiments, the shipper can be an online retailer, e-commerce platform, which sends items from a centralized location, or from a retail location, individually to recipients. In some embodiments, a retailer may send a higher volume of individually addressed items for residents within an area of commerce. The distribution network can similarly provide instructions to shippers on where to drop items, when to expect a delivery resource to pick up the item at a physical retail location, and allocate resources to ensure timely pick-up and subsequent delivery.

In some embodiments, an online, catalog, mail order, or similar merchant may have a plurality of items to delivery to a geographic area. The merchant may provide item information, including intended delivery destinations, service class, item identity, special instructions, etc., for each of the plurality or items to the distribution network. The distribution network can analyze its resources and areas of commerce, and can provide instructions to the merchant on which of the plurality of items to drop at which facilities. For example, if the merchant has 100 items intended for a geographic area, the distribution network can determine that 75 are intended for delivery to a first area of commerce and that 25 are intended for delivery to a second area of commerce. The distribution network instructs the merchant to drop the 75 items intended for delivery in the first area of commerce at a first location, and to drop the 25 items intended for delivery in the second area of commerce at a second location. The item quantities described here are exemplary only. In some embodiments, all the items are intended for delivery within one area of commerce. In this case, the distribution network may instruct the merchant to drop a first portion of the items at a first facility and a second portion of the items at a second facility. The distribution may request the merchant to drop a first portion of the items at a first facility within the area of commerce, and to leave a second portion of the items at the merchant location for pickup by a resource. The items in the first and second portions of items can be determined based on the intended destinations for the items.

Once the items are dropped at the location, the distribution network can determine how to route resources for delivering the items. For example, some resources may arrive at the drop location to pick up some items for delivery, and some other items may be transported to another facility within the area of commerce for subsequent sorting and delivery.

In some aspects described herein, the scheduling system and methods of the present disclosure use package or parcel transportation vehicles that are dedicated for use by the scheduling system and method to create a transport network for store-to-door or door-to-door same-day delivery that leverages a preexisting workforce of delivery providers, such as USPS mail carriers, within a specified area. In various embodiments, the dedicated item transportation vehicles may be trucks or vans or the like (such as USPS delivery vans), that drive a route, and that halt at particular stops, in order to provide one or more parcels or items to a delivery provider, to pick-up an item from a merchant, seller, customer, or delivery provider (e.g., mail carriers or package carriers or simply carriers), to transfer an item from one carrier to another, to offload and on load packages, etc. The route and stops can be dynamic or can be static, and can be determined by the scheduling system and method and communicated to the dedicated item transportation vehicles and to the delivery providers. In some implementations, the route and stops may be communicated dynamically and/or in real time. The transportation vehicles routes and stops, the dedicated item transportation vehicles can be considered analogous to public transportation buses, and as used herein, the term “bus” is used interchangeably with “item transportation vehicle” or “dedicated item transportation vehicle.”

The disclosed distribution system and method can supplement the existing carrier workforce with additional ingest of package volume from brick and mortar stores and the like based upon service level agreements associated with the various stores.

In some embodiments, a recipient's orders to a brick and mortar store be fulfilled in the morning and then the packaged orders are ready for pickup and delivery starting at 10 o'clock and moving throughout the day. The brick and mortar store communicates this to the scheduling system, which analyzes resource availability and other factors to allow creation of a scheduled pickup, or to set an alternate time, for the individual carrier whose walking delivery route includes the store. The individual carriers may also pick up ad-hoc or unscheduled packages along their route. The disclosed system and method leverages the existing technology of carrier location data, (also known as GPS breadcrumbs), which is provided by the carrier's hand-held device to the scheduling system, so that scheduling system knows the location of an individual carrier as they're walking along their delivery routes. By using location breadcrumb information, obtained from GPS-enabled transportation (e.g. bikes, cars, trucks, vans, trains, planes, drones, etc.) and/or GPS-enabled handheld devices (e.g. mobile phones, tablets, laptops, GPS-enabled fleet devices, mobile delivery devices (MDD's), etc.), to dynamically determine optimal pickup and delivery routes and intelligently dispatch carriers and transportation vehicles based on optimal scenarios, e.g. the systems and methods of the current system are continuously aware of fleet vehicle and carrier locations and uses the location information along with other pertinent information (e.g. weather and traffic conditions, transit time, pickup and destination information, item details, etc.) to intelligently determine an optimal combination of route, carrier, and transportation type that would fulfill a pickup and delivery service request.

The disclosed systems and methods also leverage a network of intelligence and information based upon geographic points, which can be referred to as nodes. Nodes can be locations where a delivery resource or customer can meet another delivery resource or customer to hand-off, pick-up, or exchange items. Nodes, as described herein, can be located at set locations for a particular geographic delivery area or for an area of commerce. A transfer node can be a geographic location or point where an item can be picked up, deposited, or transferred from one resource to another resource. A dynamic routing system may be configured to identify, store, modify, delete, or otherwise manage a list or database of predetermined transfer nodes. When a pickup/delivery request is subsequently received that can be fulfilled using a plurality of routes as described above, the dynamic routing can include the selection of one of the predetermined transfer nodes as a location for two resources (e.g., a pickup resource, a delivery resource, and/or an intermediate resource) to meet and transfer the item.

Transfer nodes may be identified based on one or more of a variety of selection factors. Identified transfer nodes can be stored and accessed by the dynamic router. In some embodiments, potential transfer nodes may be identified based on their proximity to a plurality of resource routes (e.g., carrier routes). For example, potential transfer nodes may include intersections, pedestrian-friendly areas, parks, plazas, etc., located along portions of existing resource routes that are in relatively close proximity to one or more other nearby resource routes (e.g., within a threshold distance such as within 0.25 miles, within 10 blocks, within a distance corresponding to a walk time of 1 minutes, 2 minutes, 5 minutes, 10 minutes, etc.). In another example, potential transfer nodes may include locations that are not located directly along a resource route but are disposed within a similar threshold distance of two or more resource routes. Accordingly, the transfer node locations are selected such that resources traveling along two different resource routes can stop along their routes and/or briefly deviate from their respective routes to meet at a node to transfer one or more items

Various additional selection factors may be considered to select transfer nodes from among the potential node locations. In some embodiments, at least some transfer nodes may be selected based on historical location data associated with resources. In one example, GPS location data received from mobile delivery devices carried by resources may indicate that resources frequently spend at least a threshold time (e.g., at least 30 seconds, at least one minute, at least two minutes, at least five minutes, etc.) at some potential node locations (e.g., a location of an item storage or retrieval box, a location where resources frequently park their vehicles during “park and loop” operations, etc.). In some embodiments, the selection of such locations may advantageously allow for two resources to meet and transfer items without undesirably delaying one or both resources. Moreover, if a transfer node is a frequent vehicle parking location, a transfer may be effected by instructing one resource to drop off an item in a parked vehicle or retrieve an item from a parked vehicle while the resource associated with the vehicle is not present, further reducing the additional time required for one or both resources during a transfer. A node can also be a location where more than one delivery resource arrives at, passes through, or goes near during a day, or during performance of a route. For example, if two or three, or more, different delivery resources routinely pass through a location, then this location may be selected as a node.

Some locations should not be considered as nodes. For example, an intersection may not be selected as a transfer node if one or more roads at the intersection do not have sidewalks or are frequently highly congested. In another example, some outdoor locations may not be used as transfer nodes during adverse weather conditions if the locations are known to lack shelter structures. In yet another example, existing transfer nodes may be removed (e.g., deleted from a database, etc.) based on one or more adverse reports from resources traveling to or from the transfer nodes (e.g., adverse reports related to safety, crime, travel delays, etc.). Accordingly, by selecting and optimizing the set of transfer nodes utilized by the dynamic router, item transfers between resources may be achieved with minimal impact to the resources' safety or the timeliness of the deliveries along the resources' regularly planned routes. The selection and use of nodes, and the same day delivery concepts can be similar to those described with regard to U.S. application Ser. No. 16/385,586, filed Apr. 16, 2019, the entire contents of which are hereby incorporated by reference.

The transportation nodes can include one or more sub nodes, which may located on secondary arteries. Depending upon the details of a particular service level agreements with an individual customer (e.g., brick and mortar store), the scheduling can be created such that a customer employee personally meets the delivery resource, or “bus” at a pickup point, where the merchant, seller, retailer, etc. places the package on the bus. The delivery schedule can allow schedules from the brick and mortar stores to align with a bus schedule and vice versa.

In some embodiments, the delivery schedule can be based on a scheduled route, like a fixed bus route, but the stops may change depending upon the service level agreements, which delivery provider has packages for that day, where the packages are going, etc. The delivery schedule is dynamic, and may be based on optimizing travel routes for the day, including using or avoiding major arteries in the delivery area and which brick and mortar stores have packages for that day. Also, the delivery schedule may be based on the timing of the pickup of those stores and where the delivery providers are in the delivery area, which would affect the nodes and meet and pickup points.

The scheduling system can determine if a particular delivery resource is nearing, approaching or leaving a delivery point or a pick-up point or how far away the delivery provider is from a delivery location. If packages are available for pickup along a delivery provider's route, then the delivery provider may pick up those packages and put it in their vehicle. If the package is for another delivery region, the delivery provider can go to their meet point with a bus route, and can hand the packages off to another delivery provider. The calculations and dynamic scheduling takes place and generates a new schedule.

For example, when a person places an order for a product with a store, the store processes the order using their fulfillment process. The store prepares the product for shipment by addressing the package with the ordering person's (i.e., recipient's) information and a barcode for delivery. The package is put into the store's inventory of data that is sent to the delivery service (e.g., USPS) and that indicates that the package is now ready for pickup. And as soon as the transaction is complete, if that transaction happens prior to the service level agreement pickup time, then the shipment is for this day. Otherwise, it may roll over to the next day. And if it is for this day, the shipment information is transmitted to a cloud-based server platform for scheduling calculation, which goes into a queue or database or the like with all of the other stores that are using the scheduling and delivery system. The scheduling of the resource/bus is based on where the delivery providers currently are and where they will be in the future (later in the day). Because of the use of the GPS breadcrumbs, a historical perspective is provided that allows the system to accurately predict where each delivery provider is going to be at any point in time during the day.

The areas of commerce can include one or more nodes. The system can also identify major transportation routes, for example, using major and minor transportation arteries. A calculation of transit time for the delivery resource can then be performed based on the nodes and the associated drive time between them to determine an optimum time and/or location for meet or pickup points. Each time parameter associated with a node can include a variable time buffer length to allow for typical delays along a travel route. In various implementations, the time value segments of the major and minor transportation arteries can be represented as data points, which the system can analyze using database graphing techniques. The database graphing techniques can be performed in real time or in near real time. In some embodiments, the areas of commerce can include service zones, which are sub-areas within an area of commerce within which the distribution system can provide a particular service class, such as same-day delivery, next day delivery, 2-day delivery, etc.

In some embodiments, third parties or package consolidators can be employed as package collection locations where customers can send or drop off packages that are to be delivered to recipients. For example, brick-and-mortar stores can contract with third parties or package consolidators to provide for a centralized package pickup location. In some examples, business partners, such as hotels or other stores, can be used as package collection points, pickup points, or meet points. Such locations can be identified as nodes.

In some such examples, a post office, distribution facility, merchant facility, or other location can act like a consolidator, where the post office can receive packages at multiple times a day with the expectation that the packages are going to get delivered that day. In this example, dedicated item transportation vehicles can be positioned at the post office. The scheduling system calculates meet points, for example, at nodes, and schedules these vehicles from the post office to provide the packages to other delivery resources for delivery within the carrier's routes throughout the day.

According to examples of the present disclosure, a computer-implemented method and system for scheduling and implementing shipment of a first package is provided. In various implementations, a computer-implemented method can comprise obtaining, over a communications network, provider data, customer data, historical route data for one or more delivery providers from a plurality of data sources; obtaining, over the communications network, current location data and current time data associated with the one or more delivery providers and/or buses; analyzing, by one or more hardware processors, the current location data and the current time data that are obtained with respect to the provider data, the customer data, and the historical route data that are obtained using a database graph search algorithm; determining, by the one or more hardware processors, a first receipt location and a first receipt time for the first package based on the analyzing; determining, by the one or more processors, a first delivery provider and/or bus for the first package based on the schedule; and providing, over the communications network, instructions to a first delivery provider computer device associated with the first delivery provider of the one or more delivery providers or bus to receive, handoff, and/or deliver the first package based on the schedule

In examples, a computer-implemented method can further comprise obtaining weather data from a weather data provider and traffic data from a traffic data provider and wherein the analyzing further comprises using the weather data and the traffic data in the graph search algorithm.

In examples, a computer-implemented method can further comprise continuously updating the analysis based on updated information; determining that the first delivery provider will not be at the first receipt location at the first receipt time; and providing the instructions to a second delivery provider of the one or more delivery providers to receive or delivery the first package.

In some examples, historical route data comprises one or more routes taken by each of the one or more delivery providers. The one or more routes are segmented to a plurality of sections, wherein each of the plurality of sections associated with a start point and an end point. Each of the plurality of section is associated with a transit time to travel a length of each section.

In some examples, a computer-implemented method can further comprise determining a second receipt location and a second receipt time for a second package based on the analyzing; and providing instructions to a third delivery provider of the one or more delivery providers to receive or deliver the second package based on the second receipt location and the second receipt time. The third delivery provider can be the first delivery provider.

In some examples, instructions can be overlaid or integrated within a graphical representation of map associated with the first delivery location.

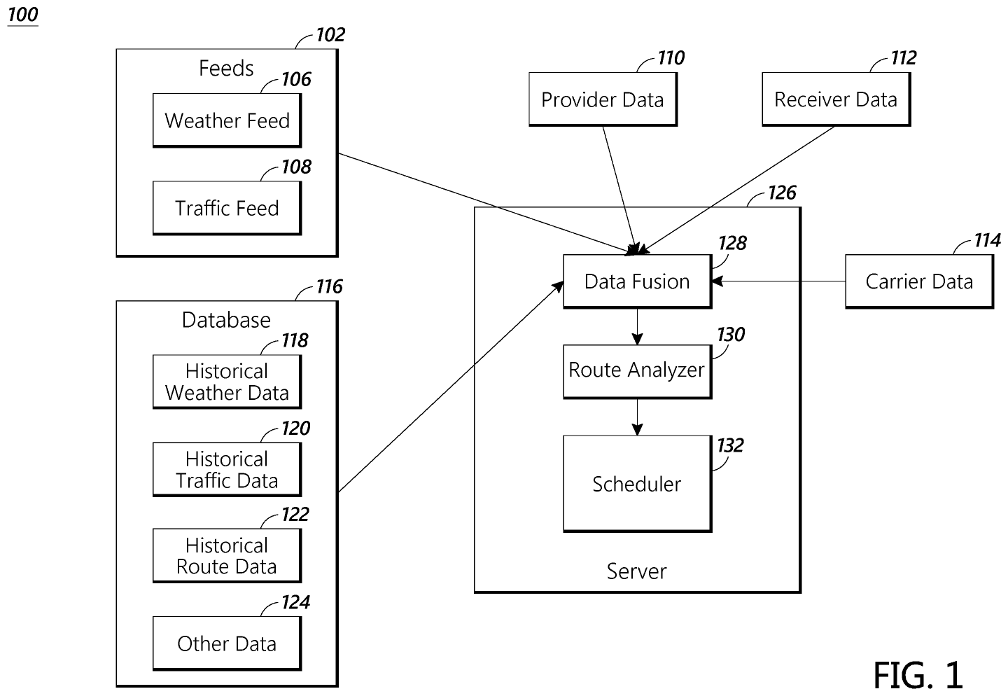

FIG. 1 shows a system 100, which may be implemented using one or more computing systems, for providing scheduling or delivery data for a package, according to examples of the present disclosure. The computer system 100 comprises a server 126 that is configured to obtain a variety of data, analyze the data using a database graphing algorithm, and provide one or more locations and times for package receipt and/or delivery. The server 126 can include one or more hardware processors, such as one or more CPUs and graphical processing units. The server 126 can be a virtual server hosted by cloud computing service. The variety of data can comprise one or more data feeds 102. The one or more data feeds 102 can comprise a weather data feed 106 from a weather data feed provider and a traffic data feed 108 from a traffic data feed provider.

The weather data feed 106 can include current weather conditions that may be impacting resource activity within the local area of commerce. The weather data feed 106 can include areas that are impassible, areas which are clear, and the like. The server 126 can use the weather information to identify nodes which are available, which are unavailable, which nodes should be prioritized over others, etc. The server 126 can further use the weather data feed 106 information to modify, update, or determine transit times for resources. The server 126 can adjust schedules, send notifications, etc., based on the weather data feed 106. The weather data feed 106 can include future weather predictions which may impact resource movement and availability and pick up and delivery point accessibility.

The traffic data feed 108 can include current or real-time traffic information from the local area of commerce and can provide historical traffic information. The traffic data feed 108 can be used to create, update, modify, and plan resource usage. The server 126 can use the historical and current traffic information to generate routes, to identify nodes that should be used at specific times of day, which nodes should be avoided, to plan resource travel time, and the like.

The variety of data can also comprise provider data 110, receiver data 112, and carrier data 114. The provider data 110 can comprise item information for items which have been purchased, items which are to be delivered and/or provided to a recipient. The item information can include an identifier of the sender/shipper/merchant, the origination location, the intended recipient, payment information, delivery point, service class requirements, identifiers or codes on the items, customer preferences such as preferred carriers, shipping methods, shipping speeds, and special requirements for shipments, or any combination thereof. The receiver data 112 can comprise data related to a recipient (e.g., individual, a brick and mortar store) such as, for example, account information, personal information, special delivery instructions, contact information, shipment history, statistical data such as trends or patterns derived from shipment history, and receiver preferences, service class requirements, destination facility information, such as whether there is a loading dock, warehouse, etc., at the delivery point, accessibility for resources, (e.g., whether the delivery location can accommodate a semi-truck, van, etc.),

The carrier data 114 can include data related to delivery resources (e.g., mail carriers, vehicles, etc., as described elsewhere herein) including location information. The carrier data 114 can include data related to transit in-progress for tracking item and resource location, and can include a delivery itinerary/schedule, time-stamped GPS data, package scan data, carrier information, transportation method, shipping speed, and information regarding delivery modifications. Carrier data 114 may also include statistical data derived regarding the route, such as trends and patterns. Carrier data 114 can also include size of the delivery fleet and/or size of a particular delivery vehicle in the delivery fleet. Carrier data 114 can be include location information for resources, such as vehicles and delivery personnel, and can be obtained using GPS enabled devices communicating location and/or bread crumb information to the server 126.

The server 126 can communicate with one or more memories 116, such as databases, that can receive, store, and distribute any and all data related to methods disclosed herein. For example, memory 116 may store historical weather data 118, historical traffic data 120, historical route data 122, and other relevant data 124. Historical weather data 118 can include weather data from one or more weather data sources, including, but is not limited to, the source of the weather feed 106. The historical weather data 118 can be based on one or more targeted delivery areas. Historical traffic data 120 can include traffic data from one or more traffic data sources, including, but is not limited to, the source of the traffic feed 108. The historical traffic data 120 can be based on one or more targeted delivery areas. Historical route data 122 can include data specific to one or more routes and to a carrier(s) that is associated with those one or more routes. Each route of the one or more routes may be segmented into a plurality of route segments and each of the plurality of route segments can be associated with a particular transit time to travel the distance of the plurality of route segments. Historical route data 122 can include data specific to carriers, for example, scheduling data and delay data. Scheduling and delay data may include, for example, timetables, information regarding delays, mechanical breakdowns, accidents, and cancellations. The other data 124 can include, but are not limited to, historical provider data, historical receiver data, and historical carrier data. In some embodiments, the memories 116 can be embodied in one or more data stores.

In some embodiments, the memory 116 can store routes, areas, segments, and the location of nodes for a geographic area, for an area of commerce, or for any other geographic region. The memory 116 can also store real-time or near real-time information regarding the location, availability, past workload, and predicted workload for the delivery resources within an area of commerce, a segment or an area of commerce, or other desired division or subdivision of the distribution network.

The data from the feeds 102, the provider data 110, receiver data 112, carrier data 114, and the memory 116 are provided to a data fusion element 128 of the server 126. The data fusion element 128 can include one or more algorithms that can combine, aggregate, and/or sample data from the variety of data sources. A route analyzer 130 of the server 126 can obtain the output from the data fusion element 128. The route analyzer 130 can include one or more algorithms that can determine one or more appropriate routes for a delivery resource and/or for a carrier(s) that can be used to receive a package from the one customer and/or determine one or more appropriate routes that can be used to deliver the package to a recipient. In one non-limiting example, an algorithm of the one or more algorithms to determine an appropriate route is a trained neural network that employs database graphing to determine an optimum or near-optimum route, which may be based on one or more predefined rules. The one or more rules can be based on one or more factors including, but are not limited to, the service-level agreement with a particular customer (e.g., provider of the package) that guarantees a standard of handling of the package, i.e., time of delivery, handling of the package, proof of receive or delivery of package, etc. The results of the route analyzer 130 are provided to a scheduler 132 where instructions are provided to a computing device of the delivery provider and/or to computing device on the bus (or with the driver of the bus) to receive or deliver the package.

The server 126 and its components can use inputs from the data feeds 102, the memories 116, and the other data to develop routes. In some embodiments, the server 126 can develop routes and schedule activities for resources including setting routes, identifying nodes, identifying pick-up points, transfer points, and the like by using all the inputs of the system 100.

The scheduler 132 can comprise a scheduling module, one or more processors in communication with one or more memories. The scheduler 132 is configured to receive provider data 110, receiver data 112, and carrier data 114, along with information from the feeds 102, and the database 116, in order to generate scheduling information for the distribution network resources. The scheduler 132 can schedule resources, such as vehicle, at distribution network facilities and customer facilities in the area of commerce. The scheduler 132 can receive inputs regarding service class, priorities in distribution, item volumes, etc., in order to generate an efficient and timely schedule for delivery resources. In some embodiments, the scheduler 132 includes a number of different modules each performing one or more portions of the functions of the scheduler 132.

The scheduler 132 can be configured to determine when and where vehicles, carriers, or other resources, both from the customers and the distribution network, can arrive and depart from distribution facilities or other locations. The scheduler 132 can provide optimum time slots to some customers, loads, etc., based on price paid, service class, priority, or other factors. In some embodiments, the scheduler 132 can evaluate volumes of incoming and outgoing items in order to schedule resources within the area of commerce. The scheduler 132 can be accessed by merchants and the distribution network via an API, and can be called or provide call outs via an API.

The system 100 can be configured to provide a large number of services, including pick-up, delivery, warehousing, same day delivery, volume planning and prediction, transactions between merchants, between merchants and individual recipients, and the like. Individual services can be offered via the API as microservices. For example, a microservice can be a merchant to merchant drop of inventory. Another microservice can be a delivery from a warehouse store to a recipient business. Another microservice can include same-day pick-up and delivery of an item from a merchant to an individual recipient.

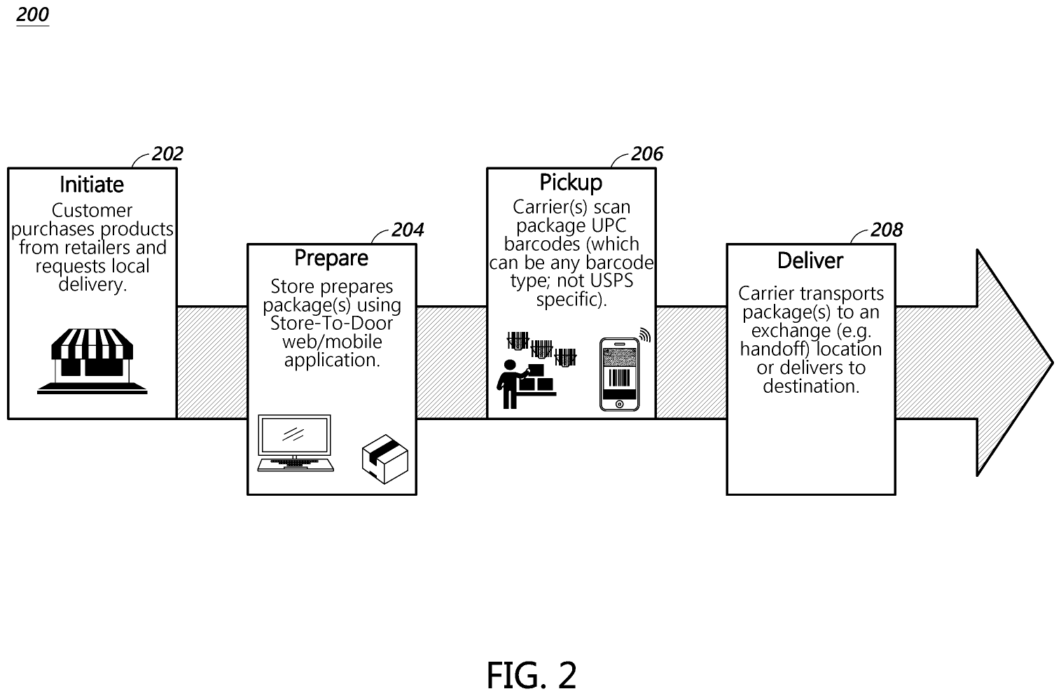

FIG. 2 shows an exemplary method 200 for scheduling and pick-up and delivery of an item or a plurality of items. The method 200 comprises initiating, at 202, a scheduling and delivery. For example, a person purchases one or more products from one or more retailers, e.g., a brick and mortar retailer. During the purchasing process, the person request local delivery for one or more first products of the one or more products. The method 200 continues with preparing, at 204, the one or more first products for delivery. For example, a first retailer of the one or more retailers prepares the one or more packages for the one or more first products using a web/mobile computer application, which can be a store-to-door application or microservice. Preparing the items for delivery in 204 can include accessing a website, application, or the like, such as the system 100, to request pick-up and/or delivery of the items. The items can have a code applied thereto, such as a barcode or other computer readable code. The code can be a unique identifier. The code can be generated by the system 100, or can be generated by the merchant and applied to the item. The merchant can supply the code to the system 100 so the item can be recognized as it moves in the local area of commerce via the distribution network. In response to the request from the merchant, the scheduler 130, and the system 100 generally can determine a schedule for pick-up and delivery, a route, identify one or more resources to use in the pick-up and delivery, nodes for any transfers, and the like. The system 100 can receive any special instructions from the merchant, and can incorporate those into the plan for pick-up and delivery of the item.

The method 200 continues with picking-up, at 206, the one or more packages by a distribution network, or by instructions to the merchant on where to drop the item(s). Continuing with the example, one or more delivery providers, e.g., carrier(s), scans the one or more packages' respective barcodes, unique computer readable codes, i.e., UPC barcodes or distribution network codes, delivery barcodes, or other computer readable codes, or gathers delivery information using some other similar digital tagging and tracking product or technique. The UPC barcodes need not be universal pricing code barcodes, but can represent any computer readable code.

The method 200 continues with delivery, at 208, of the one or more packages. Continuing with the example, the one or more delivery providers transport the one or more packages to an exchange location, (e.g., handoff or meet point), or delivers the one or more packages to the delivery destination.

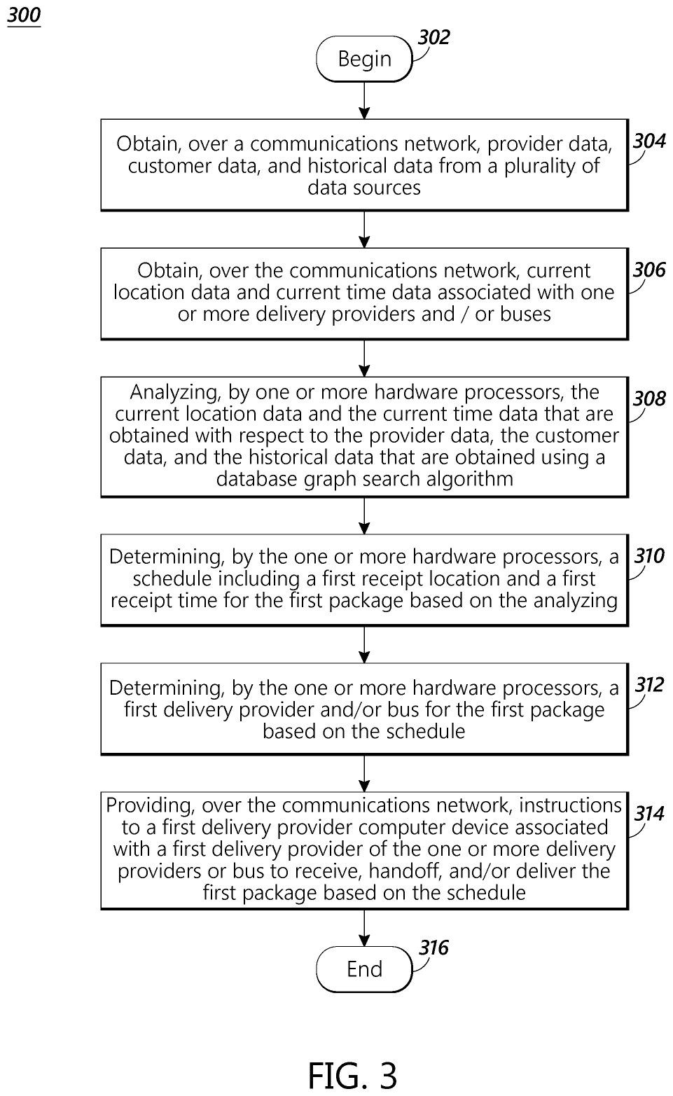

FIG. 3 is a flow chart depicting an exemplary process for delivery of a first item. The process 300 begins at step 302 and continues at step 304, wherein the server 126 obtains, over a communications network, provider data 110, receiver data 112, and historical data from a plurality of data sources 116. The server 126 can request the data from a sender, shipper, merchant, or other entity desiring to transport items in the distribution network. This request can come via an API. In some embodiments, the sender, shipper, merchant, etc. pushes data to the server 126 via an API without the server 126 specifically requesting the data in advance.

The process 300 continues at step 306 wherein the server 126 obtains, over the communications network, carrier data 112 associated with delivery resources within the area of commerce. The resources can be one or more delivery vehicles, carriers, and/or one or more buses. The carrier data 112 can include the current locations, predicted times of arrival, current routes, future stops, etc., for the delivery resources in the area of commerce. In some embodiments, the server 126 can receive carrier data 112 for all delivery resources, and then determine which delivery resources to utilize based on the pick-up or origin location of an item and the intended delivery point for the item. In some embodiments, the server 126 can request only the carrier data 112 for delivery resources which are or will be located near one or both of the pick-up or origin location and the delivery point. In some embodiments, the server 126 can request a subset of carrier data 112 for delivery resources which are near or will be near the origin point and/or delivery point, within a threshold distance of those points, which will traverse these points, or which are in a sub-area of the area of commerce which includes the origin point and/or delivery point. In some embodiments, the server 126 can request carrier data 112 for delivery resources which meet or are likely to meet a time requirement. For example, if a delivery point is near the beginning of a carrier's route, and the carrier is nearing the middle or end of the route, the server 126 may not consider that carrier in its analysis, but will prioritize another carrier who, in the future, will pass near the delivery point or origin point.

The process 300 continues at 308 by analyzing, by one or more hardware processors, the current location data and the current time data that are obtained with respect to the provider data, the customer data, and the historical route data. In some embodiments, the data can be obtained using a graph search algorithm. The server 126 determines, based on the received information which resources would be most efficient to perform the requested delivery operation. This can include determining which of the obtained carrier data 112 indicate that a single resource can pick-up and deliver the item, or determining that a plurality of resources should be employed deliver the item. In some embodiments, a first resource can pick-up the item and pass the item to a second carrier, for example, at a node. The second carrier can then deliver the item to the intended delivery point. In some embodiments, the first carrier may pick up the item and bring the item to a distribution network facility or consolidator, wherein the second carrier can pick up the item. In some embodiments, the second carrier may be specifically dispatched from the distribution facility to accomplish the delivery of the item.

In some embodiments, where the item is a pallet, container, or contains a number of individual items, the server 126 can also analyze the type of resources available, and may only consider those resources with the ability to handle the item(s).

The process 300 continues at step 310 wherein the server 126 determines, a first receipt location and a first receipt time for the item based on the analysis in step 308. The receipt location may be set by the shipper, sender, or merchant, such as a retail location, brick-and-mortar store, a residence or business of a seller, shipper, sender, etc. In this case, first the receipt location is the pick-up location or origin location. For example, if a retail store sells an item to a recipient within the area of commerce, the retail store is set as the first receipt location. The server 126 can determine a first receipt time for a resource to pick-up the item at the pick-up or origin location via the scheduler 132.

In some embodiments, the item may be provided by a merchant, shipper, or sender that has the ability to drop the item at a desired location. In this case, the server 126 can determine a drop point, or first receipt location, that will be the most efficient location for picking up and delivering the item to its intended destination. The server 126 can communicate the determined first receipt location to the merchant, shipper, or sender. The server 126 can also provide a time of pick-up at the first receipt location.

The process 300 continues at step 312, wherein the server 126 determines a first delivery provider and/or bus for the first package based on the schedule. The first delivery provider can be the one or more resources which were determined to be able to efficiently and timely pick-up and deliver the item to meet a service standard for the item.

The process 300 continues at step 314 by providing, over the communications network, instructions to the first delivery provider computer device associated with the first delivery provider of the one or more delivery providers to receive, handoff, and/or deliver the first package based on the schedule. The server 126 can send a notification, alert, or warning to a mobile computing device regarding the existence of a new pick-up or delivery, and/or a handoff destination. The mobile computing device can receive or provide turn-by-turn directions to the new pick-up or handoff point. The process 300 ends at 316.

In some embodiments, the instructions can include re-direct instructions, which can cause the system 100 to re-allocate a delivery resource or re-evaluate delivery times. A re-direct can be a change of pick-up location or a change of delivery location. In some embodiments, the delivery point can be a community partner, or a location specifically designated for residents of a neighborhood, block, street, etc. to have packages safely delivered until the recipient is able to physically pick up the package.

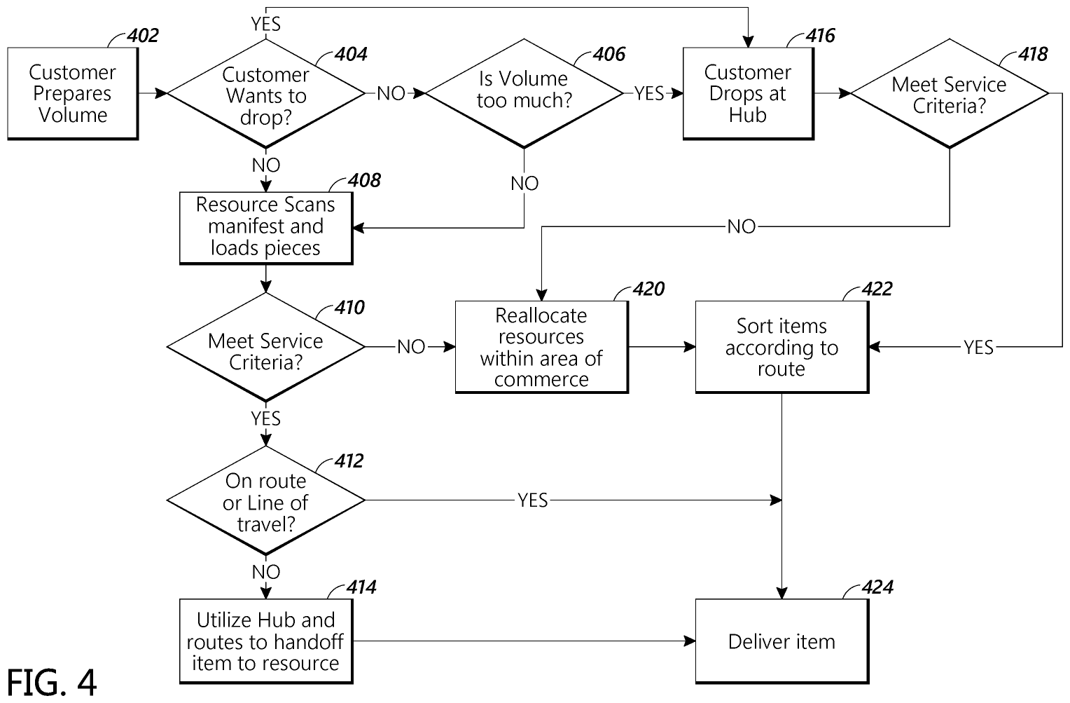

FIG. 4 shows a computer-implemented method for same day scheduling and shipment of a package, according to examples of the present disclosure. The process 400 begins at 402 where a customer prepares a volume. The volume can be a manifest a database, file, or other list of items and item information of one or more items to be delivered within a geographic area. The volume can include an identifier for items to be delivered, item information including item weight, size, type, etc. The volume can manifest a plurality of items to be delivered to one or more recipients within the geographic area. In some embodiments, the volume can be prepared for items to be delivered within an area of commerce, as described herein.

Each item for delivery can be characterized into a delivery category. In some embodiments, the delivery can be categorized by deliverer type, which can include city, rural, new type (flex), career/flexible, HCR, crowdsource, third party, or employee after-hours delivery. The delivery can also be categorized by delivery mode, which can include door, PO centralized, locker, or shared pickup. The delivery categories can be utilized by the server 126 in determining how to route items, how to allocate resources within the area of commerce, etc. The categories can be used in step 420, where resources are allocated, as described below.

Process 400 continues to decision state 404, wherein the server 126 receives information regarding whether the customer wants to drop the plurality items at a distribution network facility. If a customer desires to drop the items at a distribution network facility, the process 400 moves to block 416, wherein the customer drops the items at a hub. The server 126 can determine at which hub the plurality of items should be dropped, as described elsewhere herein, and can communicate this information to the customer prior to the customer dropping the items. In some embodiments, the items may be dropped at more than one distribution network facility. In this case, the customer will be informed at which facilities which items should be dropped. In some embodiments, a hub can be a distribution facility, a regional facility, a distribution hub, a unit delivery facility, such as a post office, and the like. In some embodiments, the system 100 will determine which location is nearest the customer or the origination point upon request of the customer. In some embodiments, the server 126 will determine which distribution network facility is best able to handle the proposed shipment by analyzing the manifest for the volume, or by analyzing item information. The server 126 can make a recommendation to the customer on where to drop the items. In some embodiments, the server 126 can identify a location having the correct resources to ensure the required service class, such as same-day or next day delivery, can be met. In some embodiments, the server 126 can determine at which facilities items should be dropped based on the service class. For example same day or next day items may be dropped at facility nearer the intended destinations, at a facility having round-the-clock staffing, and/or at facilities having dedicated same day delivery carriers or vehicles. In some embodiments, the server 126 can identify a facility to which the correct resources can be moved, re-allocated from a nearby area, or to which new resources can be assigned. In some embodiments, the server 126 can determine that a first portion of the items should be dropped at a first facility and that a second portion of the items should be dropped at a second facility, based on the intended delivery destinations for the items, service class, resource availability, and the like. These communications between the components of the system 100 and the customer can occur via a user interface, such as a software application, a web interface, a dedicated connection or terminal, and the like using APIs or other similar processes.

If the customer does not wish to drop the shipment at a facility, the process 400 proceeds to decision state 406, wherein the server 126 determines whether the volume is too much to pickup/sort at the pick-up location or origin location, whether additional a resources are needed to be dispatched to the store to pick up the volume of items, whether to assess additional fees or postage for the large volume and/or the additional delivery resources required, or whether the customer needs to drop the items at a distribution network facility. In some embodiments, the server 126 can determine that the customer should drop the items at a store if a class of service cannot be met if the items are not dropped, if no delivery resource is available to pick-up the item, if the item requires special handling and/or storage, etc. In some embodiments, for example, the server may determine that some items should be dropped a distribution network facility, and that other items can be picked up from the customer location.

If the volume of items is too large to pick up at the store, or if the customer does not wish to pay an additional fee for delivery resources to pick up the items, the process 400 moves to block 416 and continues. If the volume of items is not too much, the process moves to step 408, wherein a delivery resource is dispatched to the location to pick up the item.

In some embodiments, decision state 406 need not be performed, or may be performed only for certain merchants or shippers. For example, a merchant or shipper or retailer or seller may have an account with the system 100 or the distribution network which includes preferences or settings that the distribution network will pick up items from the retailer, merchant, shipper, seller, etc., and, therefore, decision state 406 need not be performed. In some areas of commerce, where the area is small and the merchant is big, or where the area is large and the merchant is small, the server 126 can determine that the resource will be dispatched to the merchant to pick up the items without determining whether the volume of items is too much. The process 400 moves to step 408, wherein a delivery resource picks up the item and can scan items, a manifest, and can load the items. in some embodiments, the delivery resource need not scan items and a manifest. In some embodiments, the delivery resource picking up the items can scan the item to ingest the item into the distribution network. The delivery resource can be a carrier as the carrier normally traverses the route which includes the location of the customer. In some embodiments, the delivery resource can be a dedicated vehicle, such as a “bus”, if there is a volume of items too large for the carrier, the carrier's vehicle, if the carrier has passed the customer location, if the customer has paid for a special service class, and/or other factors. When the delivery resource arrives at the customer, or the pick-up location, the delivery resource scans a manifest and/or scans items, and loads the items. For example, a postal carrier can use a mobile computing device (e.g., MDD) with an application to scan a barcode on the items to save the tracking data, and upload the tracking data to a centralized or decentralized storage platform.

In some embodiments, the delivery resource can make a selection on an interface on the mobile computing device when making a pickup. In this case, a scan of the item may not be necessary, and/or the item may not have a scannable code thereon. In the case where an item will not be delivered to a facility, but will be directly delivered by the carrier, or by one or more carriers, the item can be tracked based on the location of the mobile computing device in the possession of the carrier who has possession of the item. In some embodiments, handling events for the item can be inferred handling events or logical handling events, updating tracking information for the item as the carrier accepts the pick-up, moves through the distribution network, hands off the item to another carrier, delivers the item, etc.

The process 400 proceeds to step 410 where a determination is made as to whether the packages can be delivered while meeting a service class or service criteria provided by the merchant with the item information, such as same day or next day delivery. If the result of the determination at 410 is positive, then the computer-implemented process 400 proceeds to 412 where a determination is made as to whether the receipt location is on a delivery resource's route or is located on a line of travel.

If the result is negative, the process 400 moves to block 420, wherein the server 126 reviews the location, schedule, load, etc., of a plurality of delivery resources within the local area of commerce, and reallocates resources as necessary to meet the service class. For example, if the item to be picked up is along a route at a location that has already been serviced by a carrier in the same day, the server 126 can reallocate, reassign, or divert another carrier to pick up the item(s). In some embodiments, the server 126 can request a dedicated resource be dispatched to pick up the item. The server 126 also determines which resource can most efficiently deliver the item to the delivery location. The dedicated resource picking up the item at the origin location may be instructed to deliver the item to the delivery point. In some embodiments, the dedicated resource may be instructed to bring the item to a distribution facility for a node or further processing and delivery via a different resource. In some embodiments, the dedicated vehicle can deliver the item to a node, a rendezvous point, or other location to handoff the item to another resource. In some embodiments, depending on the service class, the items are transported to a distribution facility for further sortation, staging, and the like, for next day or subsequent day delivery. In some embodiments, the distribution network can enlist additional resources, such as overtime, after hours support, etc., in order to meet a same day criteria, if the items are associated with such a service.

For example, where the pick-up of the items is scheduled to occur after the regular carrier has traversed the route past the pick-up location, or where the items are to be delivered to other segments or service zones within the geographic area to locations along other carrier routes, or if the delivery is to be effected by a supplemental or additional delivery resource, the items can be taken to a central location which has a transfer facility capability. The location can be postal facility, or it can be a temporary storage unit, an enclosed, lockable volume which is useable for storing items until another delivery resource can pick up the items. In some embodiments, the storage or transfer facility can be one or more “busses.” If the shipment contains many items which are to be delivered to delivery points in one segment of the geographic area, the items intended for those delivery points can be loaded on a bus at a node, facility, or other location, and the bus can transport the items to a node, facility, or other location in the other segment of the geographic area. Other delivery resources can then pick up the items from the bus, from the central hub, from the distribution network facility, and can deliver the items to their intended delivery points.

In some embodiments, if the distribution network is not able to meet a requested service class, the distribution network can inform the customer that the service class cannot be met. In some embodiments, if the distribution network may determine that it is unable to deliver items to meet a service requirement based on a number of conditions. In this case, the distribution network can offer a discount, a reduced rate, expedited delivery, credit, or other incentive.

Referring again to decision state 412, if the results of the determination at 412 is then the process 400 proceeds to step 414 where a centralized hub/bus stop, a node, a pod, a temporary storage structure, a parcel locker, or similar device, can be used to efficiently handoff to a new delivery resource, as described elsewhere herein. Such a determination for a handoff or transfer of items can be made using processes and systems similar to those described in U.S. application Ser. No. 16/385,586, the entire contents of which are hereby incorporated by reference. If the items are on the delivery resource's line of travel, the process 400 moves to step 424, wherein the delivery resource delivers the item.

Returning now to step 416, the process 400 moves to decision state 418 wherein a determination is made as to whether the package can be delivered so as to meet the service criteria. If the results of the determination at decision state 418 is negative, similar to the decision at decision state 410, then the process 400 proceeds to 420 where the transport volume to appropriate physical hub/plant for next day delivery, as described elsewhere herein.

If the results of the determination at decision state 418 is positive or the process 400 is at step 420, then the process 400 proceeds to step 422 where packages are stored, sorted, routed, dispatched, and/or staged for delivery to the delivery point. In some embodiments, in step 422, the delivery resource having the item, or picking up the item, is instructed to deliver the item to a given point. This point can be a handoff point, a distribution facility for further processing or transportation, or the intended delivery point. For example, the server 126, can determine, utilizing the scheduler 132, and/or a dynamic routing tool, with how to distribute the items received at the hub or the facility to the delivery resources to meet the same day criteria. In some embodiments, the dynamic routing tool can identify “busses” to travel with a plurality of items to various points, such as nodes, in various segments in the geographic area to meet with delivery resources like carriers who are traversing their routes, or who will be traversing their routes at estimated times of the day. In some embodiments, step 422 may not be included, for example, where the item does not need to be moved to a facility prior to delivery by the delivery resource.

The process 400 proceeds from step 414, if the results are positive, 412, or 422 to step 424 where the delivery is accomplished. The delivery can be accomplished to the requested or indicated delivery point by a delivery resource. In some embodiments, the delivery point can be an address, and can be delivered along a normal carrier route. In some embodiments, the delivery point can be dynamic, and can be selected by the recipient before or during item transport. The delivery point can be a distribution network facility and the recipient can be notified that the item is at a distribution network facility, ready for pick-up.

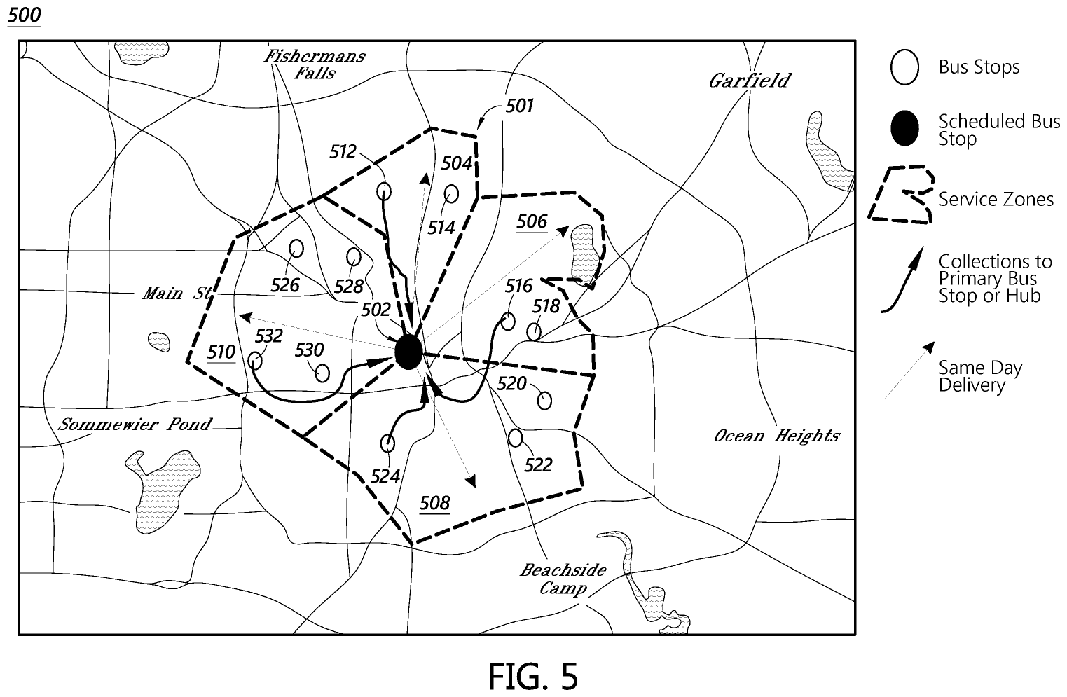

FIG. 5 shows an example of a map 500 for scheduling and delivery, according to examples of the present disclosure. The map 500 shows an area of commerce 501. The area of commerce 501 includes a bus stop or central hub 502 and a plurality of service zones 504, 506, 508, and 510. Areas within the plurality of service zone 504, 506, 508, and 510 can be serviced using delivery processes disclosed herein, as represented by the respective straight arrows within each zone. Each of the plurality of service zones 504, 506, 508, and 510 can include one or more dynamic bus stops, which are determined by the scheduling system as described herein. For example, service zone 504 includes bus stops 512 and 514, service zone 506 includes bus stop 516 and 518, service zone 508 includes bus stops 520, 522, and 524, and service zone 508 includes bus stops 526, 528, 530, and 532. Packages can be transported by dedicated delivery vehicles from bus stop 512, 516, 524, and 532 to the scheduled bus stop 502, as indicated by respective curved arrows. In some examples, the size of the services zones 504, 506, 508, and 510 can depend on the density of population for the particular geographic region.

To illustrate, if a customer has a large number of items to drop at a postal facility for delivery, the distribution network can analyze the resources for a geographic area for the day on which the delivery is to occur. In some embodiments, the items can be intended for same day, next day, 2-day delivery, or any other desired service class.

The system 100 can develop a dynamic routing plan for “busses”, for carriers and other delivery resources. The items can be dropped at the central hub 502, or distribution facility. In the illustrated embodiment of FIG. 5, the area of commerce 501 is divided into the four service zones 504, 506, 508, and 510. The system 100 can determine a route for one or more busses within each service zone (depending on the volume of items), for delivery. The routes can be illustrated by the straight arrows. These routes may include a departure time from the central hub. An item at the central hub 502 in time for the departure can be sorted and loaded on to the appropriate bus, based on which service zone the delivery point is located in. The bus departs the central hub 502 with the items for delivery. The system 100 can set particular times and locations for delivery resources, such as carriers, to meet the bus, at bus stops 514, 518, 520, 522 526, and 528, for example, to transfer items to the carriers for delivery. Although the straight lines indicating “bus” routes do not necessarily meet each bus stop on the map of FIG. 5, it will be understood that the “bus” can move or travel to any desired bus stop, such as a node, without departing from the scope of the current disclosure. The system 100 can communicate the nodes, the items to pick up, directions, and any other desired or necessary information to a carrier's mobile computing device, such as an MDD, in order to ensure the transfer of items from the bus to the carrier occurs.

If a carrier picks up other items long the route which are for same day delivery, or next day delivery, or for another service class, other than items from the customer on the shipment of the current example, these items can be placed on the bus, where the items will return to the central hub to await loading on a subsequent bus, pick up by another delivery resource, etc.

In some embodiments, another customer may have items for delivery, which are picked up by carriers, delivery resources, etc. These locations can be illustrated by bus stops 512, 516, 524, and 532. The curved arrows can indicate a path for the items picked up to be delivered to the central hub 502. Once at the central hub 502, the items can be sorted, loaded onto additional busses, or busses that have returned from another trip through the service area, for subsequent delivery. In some embodiments, once the busses complete their drop off or item transfer tasks at nodes throughout the service zones 504, 506, 508, and 510, the busses can stop at bus stops 512, 516, 524, and 532, pick up the additional items to be delivered, and bring the additional items back to the central hub 502 for subsequent delivery. Although only one central hub 502 is depicted, a person of skill in the art would understand that there may be additional hubs located in one or more of the service zones, if needed, to reduce travel time, increase efficiency, etc., without departing from the scope of this disclosure.

The busses can have set departure times, as described above, and can have several scheduled departure times throughout the day. If a customer wishes to have a same day delivery, the scheduled departure time scan be communicated to the customer, and a drop time can be provided. If the items are dropped at the central hub 502, or are made available for pick-up a the bus stops 512, 516, 524, or 532 by the drop time, the distribution network can guarantee a service standard will be met, such as same-day delivery.

Although the bus routes are depicted in straight arrows, it will be understood that the bus will follow a street pattern, and may follow a route which is not a straight line. In some embodiments, the bus may have a fixed route every day, or may have dynamically created routes, as determined by the system 100.

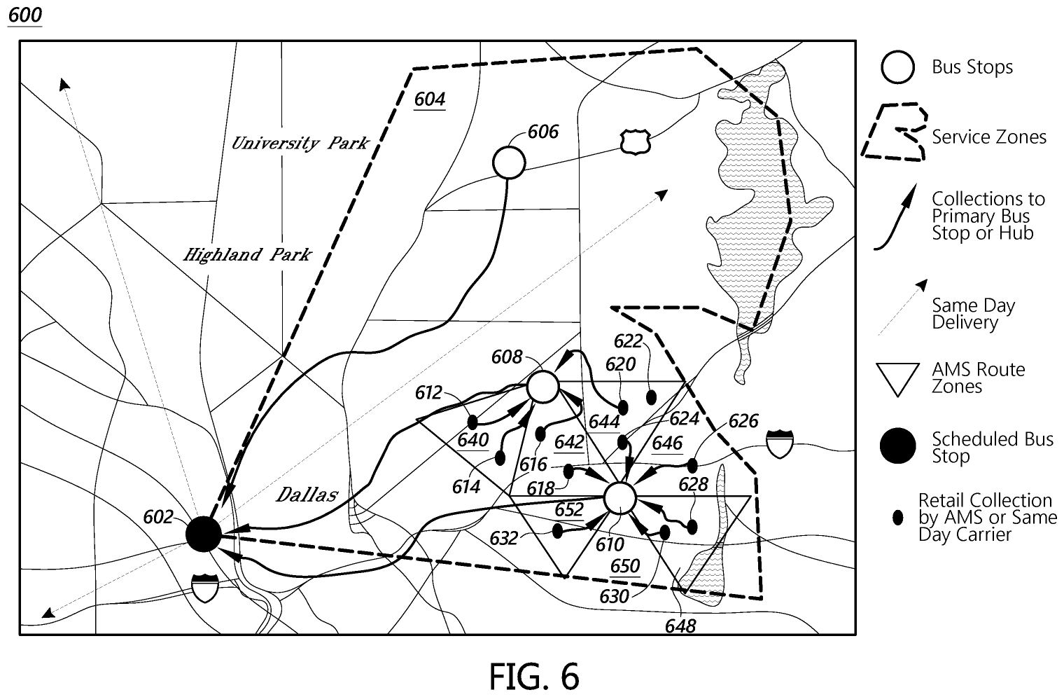

FIG. 6 shows an example of a map 600 for scheduling pick-up and delivery within an area of commerce. The map 600 shows a central hub 602 that is serviced by service zone 604. Service zone 604 can be similar to service zone 504 described above. Service zone 604 comprises bus stops 606, 608, and 610. Based on package delivery requested by retail collection at points 612, 614, 616, 618, 620, 622, 624, 626, 628, 630, 632, the service zone 604 is segmented into a plurality of dynamically created route zones 640, 642, 644, 646, 648, 650, 652, as indicated by the triangles in FIG. 6. Packages at points 612 and 614 in route zone 640 are collected to bus stop 608, packages at point 616 in route zone 642 are collected to bus stop 608, packages at point 620 in route zone 644 are collected to bus stop 608, packages at point 624 in route zone 644 are collected to bus stop 610, packages at point 626 in route zone 646 are collected to bus stop 610, packages at points 628 and 630 in route zone 648 are collected to bus stop 610, and packages at point 632 in route zone 652 are collected to bus stop 610. The collection routes are shown by the curved arrows in the figure.

The bus stops 606, 608, and 610 can be located at nodes as described elsewhere herein. In some embodiments, the entire service zone 604 can be divided into route zones, although only a portion of the service zone 604 is shown divided into route zones. The pick-ups at points 612, 614, 616, 618, 620, 622, 624, 626, 628, 630, 632 can be performed by carriers as they traverse their routes. The carriers can be alerted for a need to pick up an item on the carrier's mobile computing device, such as an MDD, or by a device in a vehicle, or both. The carrier can deliver the item picked up to the bus stops 606, 608, and/or 610. A bus can leave the central hub 602 on a route to pass by, near, or through the bus stops 606, 608, and/or 610 to pick up the items there. The busses can deliver the items to other bus stops, or can return to the central hub 602. In some embodiments, the system 100 may dispatch one or more busses to each bus stop 606, 608, 610, or can dynamically route a bus to only one or two of the bus stops 606, 608, 610, based on the volume of items to be picked up, based on the delivery points, and/or based on other item information.

In some embodiments, a bus may stop at bus stop 606 to pick up some items delivered there by delivery resource(s) who picked up the items. The system 100 may then instruct the bus to travel to bus stop 608 to transfer the items picked up at bus stop 606 to a delivery resource at bus stop 608, and to pick up other items at bus stop 608. The bus stops 606, 608, and/or can be set dynamically each day, or multiple times throughout the day. That is, the bus stops 606, 608, 610 need not be at the same physical location within service zone 604 each day. The bus stops can be at locations considered to be nodes. The system 100 can also determine the number of bus stops that should be set for the day, based on item volume, item type, item origin location and delivery point information, and other item information.

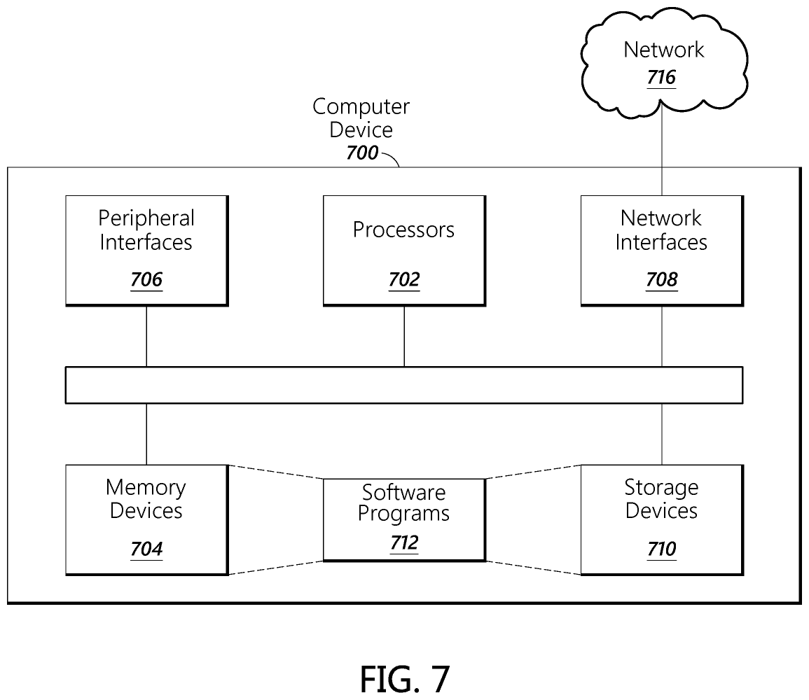

FIG. 7 illustrates an example of a hardware configuration for a computer device 700 that can be used as the server 126, or as another component of the system 100 which can be used to perform one or more of the processes described herein. While FIG. 7 illustrates various components contained in the computer device 700, FIG. 7 illustrates one example of a computer device and additional components can be added and existing components can be removed.

The computer device 700 can be any type of computer or a virtual instance of a computer hosted by a cloud computing platform. As illustrated in FIG. 7, the computer device 700 can include one or more processors 702 of varying core configurations and clock frequencies. The computer device 700 can also include one or more memory devices 704 that serve as a main memory during the operation of the computer device 700. For example, during operation, a copy of the software that supports the scheduling operations can be stored in the one or more memory devices 704. The computer device 700 can also include one or more peripheral interfaces 706, such as keyboards, mice, touchpads, computer screens, touchscreens, etc., for enabling human interaction with and manipulation of the computer device 700.

The computer device 700 can also include one or more network interfaces 708 for communicating via one or more networks, such as Ethernet adapters, wireless transceivers, or serial network components, for communicating over wired or wireless media using protocols. The computer device 700 can also include one or more storage device 710 of varying physical dimensions and storage capacities, such as flash drives, hard drives, random access memory, etc., for storing data, such as images, files, and program instructions for execution by the one or more processors 702. The network interfaces can include connections to user computer systems to interface with the computer device 700, for example, via an online portal

Additionally, the computer device 700 can include one or more software programs 712 that enable the functionality described above. The one or more software programs 712 can include instructions that cause the one or more processors 702 to perform the processes described herein. Copies of the one or more software programs 712 can be stored in the one or more memory devices 704 and/or on in the one or more storage devices 710. Likewise, the data, for example, the super zone data, utilized by one or more software programs 712 can be stored in the one or more memory devices 704 and/or on in the one or more storage devices 710.

In implementations, the computer device 700 can communicate with other devices via a network 716. The other devices can be any types of devices as described above. The network 716 can be any type of electronic network, such as a local area network, a wide-area network, a virtual private network, the Internet, an intranet, an extranet, a public switched telephone network, an infrared network, a wireless network, and any combination thereof. The network 716 can support communications using any of a variety of commercially-available protocols, such as TCP/IP, UDP, OSI, FTP, UPnP, NFS, CIFS, AppleTalk, and the like. The network 716 can be, for example, a local area network, a wide-area network, a virtual private network, the Internet, an intranet, an extranet, a public switched telephone network, an infrared network, a wireless network, and any combination thereof.

The computer device 700 can include a variety of data stores and other memory and storage media as discussed above. These can reside in a variety of locations, such as on a storage medium local to (and/or resident in) one or more of the computers or remote from any or all of the computers across the network. In some implementations, information can reside in a storage-area network (“SAN”) familiar to those skilled in the art. Similarly, any necessary files for performing the functions attributed to the computers, servers, or other network devices may be stored locally and/or remotely, as appropriate.

In implementations, the components of the computer device 700 as described above need not be enclosed within a single enclosure or even located in close proximity to one another. Those skilled in the art will appreciate that the above-described componentry are examples only, as the computer device 700 can include any type of hardware componentry, including any necessary accompanying firmware or software, for performing the disclosed implementations. The computer device 700 can also be implemented in part or in whole by electronic circuit components or processors, such as application-specific integrated circuits (ASICs) or field-programmable gate arrays (FPGAs).

A distribution network, such as the USPS, can be utilized within an area of commerce for services in addition to the delivery of items to a commercial or residential delivery point. In an area of commerce, a distribution facility for a commercial entity may routinely ship items to a business or commercial merchant. For example, a warehouse store, such as Costco or Sam's Club, or an office supply store, such as Staples, may ship pallets of items to one or more offices, businesses, etc. The distribution facility may employ its own delivery vehicles to make these deliveries within an area of commerce. In one example of the systems and methods of the present disclosure, a distribution network, such as the USPS, can make the deliveries of the pallets of items or supplies on behalf of the warehouse store or the office supply store.

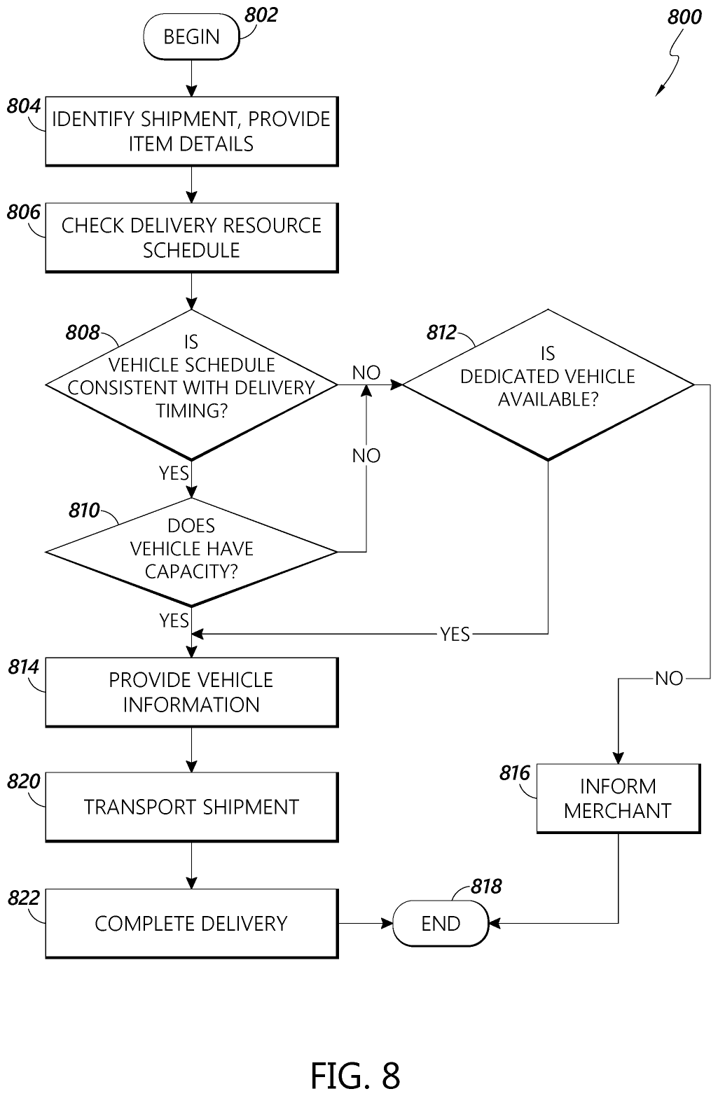

FIG. 8 depicts a method of delivering items from a commercial merchant to a business or other merchant. In one example, the merchant can be a warehouse store, and the items can be a pallet of supplies that are intended for delivery to a business, such as a restaurant, or other entity. Rather than maintaining and/or dispatching its own fleet of vehicles, the merchant may wish to see if any other delivery vehicles, such as USPS vehicles or other merchant vehicles will be passing by or close to the warehouse store and by or close to the business to which delivery is intended. If another entity has a vehicle with excess capacity which can make the delivery, the systems herein can provide an option for the warehouse store to contact the owner of the vehicle which will pass by, and to request, and pay the owner of the vehicle to make the delivery on behalf of the warehouse store.

A process 800 begins in step 802. The process 800 moves to step 804, wherein a shipment is identified or item details are provided. The shipment can be identified by a merchant system or a distribution network. The item details can be provided via an API to a distribution network system or other system. The item details can be an identification of the items, the origin or pick-up location for the items, a volume of a load, such as a pallet size, container size, etc. The item details can also include a destination delivery point, and a requested delivery time. A coordinating device, such as a processor or system similar to those described elsewhere herein can obtain the item information, load size, etc. from the merchant.

The process 800 moves to step 806, wherein the delivery resource schedule is checked to determine resource availability. The scheduler of the coordinating device can compare the schedule of delivery resources that will be passing by or near the origin or pickup location to identify a type of vehicle, a time a vehicle will pass the location, whether the vehicle has sufficient excess capacity to accept the load, a time the vehicle can be at a delivery point, and other factors described elsewhere herein. In some embodiments, the coordinating device can determine which resources in the local area of commerce will be passing or are scheduled to pass within a threshold distance of the origin or pick-up location and/or the destination. In some embodiments the threshold distance can be 1/10^{th} of a mile, ¼ mile, ½ mile, 1 mile, 2 miles, or any other desired distance. In some embodiments, the determination may be based on whether a delivery resource, such as a vehicle which is not passing within a threshold distance, but which has a schedule that would permit travel to the origin or pick-up point without jeopardizing a scheduled delivery time.

The process 800 moves to decision state 808, wherein it is determined whether the vehicle schedule will meet the schedule requirements for the preparer of the load, or the request of the recipient. If the scheduler checks whether there will be a vehicle passing by, or near the origin location or pick-up location, while traversing its preassigned route, or in other words, is not a dedicated vehicle dispatched solely to pick up the load. The scheduler will also determine whether the vehicle will be passing by or near the delivery point for the load on or before the requested delivery date. In some embodiments, the operations of process 800 can occur in the system 100, the system 700, or a similar system. The system can include an interface that the merchant, shipper, etc., uses to interact with the system 100, 700, or other system.

If the vehicle's schedule and its appointed route will support pick-up and delivery of the load on or before the requested delivery date, the process 808 moves to decision state 810, wherein it is determined whether the vehicle has sufficient capacity to pick-up the load. The coordinating device can receive information regarding the shipment, load, or items as in step 804. The coordinating device can determine whether the vehicle meeting the schedule has sufficient space, volume, or room to receive and transport the load.

If the vehicle has sufficient space available, the process 800 moves to step 814, wherein the vehicle information is provided to the sender or merchant.

In some embodiments, the decision states 808 and 810 can include further determinations on the cost of providing a pick-up and delivery of the shipment or load. For example, the cost may increase based on the distance the vehicle needs to travel, the distance the vehicle deviates from an appointed route, how much time the pick-up and delivery adds to the vehicle schedule, and other factors. The coordinating device can determine a cost of service based on these factors, and can provide the cost to the merchant via an API. The merchant can either accept or reject the service based on the cost, timing, or other factors. If the merchant rejects the service, the process 800 ends.

In some embodiments, the decision states 808 and 810 can be performed in reverse order, that is, the determination of available capacity can occur before the determination regarding schedule timing. In some embodiments, the decision states 808 and 810 can be performed substantially simultaneously.

If, at decision state 808 or 810, the vehicle cannot meet the schedule or the capacity requirement, respectively, the process 800 moves to decision state 812, wherein the coordinating device determines whether a dedicated vehicle can be dispatched to pick-up and deliver the load. If a dedicated vehicle can be located within the area of commerce and can meet the schedule and capacity requirements, then the process 800 moves to step 814, wherein vehicle information is provided.

If a dedicated vehicle cannot be found, the process moves to step 816, wherein the merchant is informed that no vehicle is available. The process then ends in step 818.

In some embodiments, the process 800 does not include decision state 812, and if there is no vehicle available to meet the schedule or capacity requirements, the process 800 moves directly to step 816, wherein the merchant is informed that no vehicle is available.

Returning to step 814, the coordinating device can provide vehicle information to the merchant, for example, via an API. The vehicle information can include an identification of the type of vehicle that will be picking up the load, the time the vehicle will arrive at the merchant's indicated origin point or pick-up point, the amount of capacity available, the predicted time of delivery of the load to the delivery point, and any required instructions.

The process 800 moves to step 820, wherein the shipment is transported. Transportation can include pick-up, transit, and delivery of the shipment or load. The vehicle can track the item using location enabled computing devices on the vehicle and/or in a device carried by the driver. The coordinating device can identify pick up and drop off events based on the geographic location of the driver and/or the vehicle. The transit of the shipment can be performed at the beginning or end of the vehicle's pre-appointed route. In some embodiments, the scheduler can determine which point along the vehicle's pre-appointed route would be nearest the delivery point, and can instruct the vehicle and/or carrier to deliver the shipment at an intermediate point along a pre-appointed route.

The process 800 moves to step 822, wherein the delivery is completed, and the coordinating device informs the merchant that the shipment or load has been delivered. The process 800 moves to step 818 and ends.

The process of FIG. 800 can be advantageously used by the USPS in an area of commerce if a merchant has a load or shipment to move to another location. The merchant can, via an API or other means, ask the USPS if they have a vehicle with capacity going past either the merchant location, the destination location, or both. If the USPS has such a vehicle already intended to go past, or near, the merchant location, the destination location, or both, which has excess capacity, it is advantageous for both the USPS and the merchant to use the vehicle to transport the additional load. The USPS can provide a cost estimate, based on deviation from route, timing, size of load, etc., and the merchant can agree. The USPS vehicle will pick up the shipment or load from the merchant, and will deliver it to the recipient within an agreed upon time.

If implemented in software, the functions can be stored on or transmitted over a computer-readable medium as one or more instructions or code. Computer-readable media includes both tangible, non-transitory computer storage media and communication media including any medium that facilitates transfer of a computer program from one place to another. A storage media can be any available tangible, non-transitory media that can be accessed by a computer. By way of example, and not limitation, such tangible, non-transitory computer-readable media can comprise RAM, ROM, flash memory, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes CD, laser disc, optical disc, DVD, floppy disk and Blu-ray disc where disks usually reproduce data magnetically, while discs reproduce data optically with lasers. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Combinations of the above should also be included within the scope of computer-readable media.

The foregoing description is illustrative, and variations in configuration and implementation can occur to persons skilled in the art. For instance, the various illustrative logics, logical blocks, modules, and circuits described in connection with the embodiments disclosed herein can be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor can be a microprocessor, but, in the alternative, the processor can be any conventional processor, controller, microcontroller, or state machine. A processor can also be implemented as a combination of computing devices, e.g., a combination of a DSP and/or GPU and a microprocessor, a plurality of microprocessors, one or more microprocessors in conjunction with a DSP core and/or GPU core, or any other such configuration.

In one or more exemplary embodiments, the functions described can be implemented in hardware, software, firmware, or any combination thereof. For a software implementation, the techniques described herein can be implemented with modules (e.g., procedures, functions, subprograms, programs, routines, subroutines, modules, software packages, classes, and so on) that perform the functions described herein. A module can be coupled to another module or a hardware circuit by passing and/or receiving information, data, arguments, parameters, or memory contents. Information, arguments, parameters, data, or the like can be passed, forwarded, or transmitted using any suitable means including memory sharing, message passing, token passing, network transmission, and the like. The software codes can be stored in memory units and executed by processors. The memory unit can be implemented within the processor or external to the processor, in which case it can be communicatively coupled to the processor via various means as is known in the art.

Notwithstanding that the numerical ranges and parameters setting forth the broad scope of the embodiments are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” can include any and all sub-ranges between (and including) the minimum value of zero and the maximum value of 10, that is, any and all sub-ranges having a minimum value of equal to or greater than zero and a maximum value of equal to or less than 10, e.g., 1 to 5. In certain cases, the numerical values as stated for the parameter can take on negative values. In this case, the example value of range stated as “less than 10” can assume negative values, e.g., −1, −2, −3, −10, −20, −30, etc.

The following embodiments are described for illustrative purposes only with reference to the Figures. Those of skill in the art will appreciate that the following description is exemplary in nature, and that various modifications to the parameters set forth herein could be made without departing from the scope of the present embodiments. It is intended that the specification and examples be considered as examples only. The various embodiments are not necessarily mutually exclusive, as some embodiments can be combined with one or more other embodiments to form new embodiments.

While the embodiments have been illustrated respect to one or more implementations, alterations and/or modifications can be made to the illustrated examples without departing from the spirit and scope of the appended claims. In addition, while a particular feature of the embodiments may have been disclosed with respect to only one of several implementations, such feature may be combined with one or more other features of the other implementations as may be desired and advantageous for any given or particular function.

The technology is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, programmable consumer electronics, network PCs, minicomputers, mainframe computers, distributed computing environments that include any of the above systems or devices, and the like.

The present disclosure refers to processor-implemented steps for processing information in the system. Instructions can be implemented in software, firmware or hardware and include any type of programmed step undertaken by components of the system.

The one or more processors may be implemented with any combination of general-purpose microprocessors, microcontrollers, digital signal processors (DSPs), field programmable gate arrays (FPGAs), programmable logic devices (PLDs), controllers, state machines, gated logic, discrete hardware components, dedicated hardware finite state machines, or any other suitable entities that may perform calculations or other manipulations of information. The system hub 210 may comprise a processor 212 such as, for example, a microprocessor, such as a Pentium® processor, a Pentium® Pro processor, a 8051 processor, a MIPS® processor, a Power PC® processor, an Alpha® processor, a microcontroller, an Intel CORE i7®, i5®, or i3® processor, an AMD Phenom®, A-series®, or FX® processor, or the like. The processors typically have conventional address lines, conventional data lines, and one or more conventional control lines.

The system may be used in connection with various operating systems such as Linux®, UNIX®, MacOS®, or Microsoft Windows®. The system control may be written in any conventional programming language such as C, C++, BASIC, Pascal, or Java, and ran under a conventional operating system. C, C++, BASIC, Pascal, Java, and FORTRAN are industry standard programming languages for which many commercial compilers can be used to create executable code. The system control may also be written using interpreted languages such as Perl, Python or Ruby.

Those of skill will further recognize that the various illustrative logical blocks, modules, circuits, and algorithm steps described in connection with the embodiments disclosed herein may be implemented as electronic hardware, software stored on a computer-readable medium and executable by a processor, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such embodiment decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in software, the functions may be stored on or transmitted over as one or more instructions or code on a computer-readable medium. The steps of a method or algorithm disclosed herein may be implemented in a processor-executable software module which may reside on a computer-readable medium. Memory Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

The foregoing description details certain embodiments of the systems, devices, and methods disclosed herein. It will be appreciated, however, that no matter how detailed the foregoing appears in text, the systems, devices, and methods can be practiced in many ways. As is also stated above, it should be noted that the use of particular terminology when describing certain features or aspects of the invention should not be taken to imply that the terminology is being re-defined herein to be restricted to including any specific characteristics of the features or aspects of the technology with which that terminology is associated.

It will be appreciated by those skilled in the art that various modifications and changes may be made without departing from the scope of the described technology. Such modifications and changes are intended to fall within the scope of the embodiments. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As used herein, the terms “determine” or “determining” encompass a wide variety of actions. For example, “determining” may include calculating, computing, processing, deriving, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

As used herein, the term “message” encompasses a wide variety of formats for communicating (e.g., transmitting or receiving) information. A message may include a machine readable aggregation of information such as an XML document, fixed field message, comma separated message, or the like. A message may, in some implementations, include a signal utilized to transmit one or more representations of the information. While recited in the singular, it will be understood that a message may be composed, transmitted, stored, received, etc. in multiple parts.

As used herein a “user interface” (also referred to as an interactive user interface, a graphical user interface or a UI) may refer to a network based interface including data fields and/or other controls for receiving input signals or providing electronic information and/or for providing information to the user in response to any received input signals. A UI may be implemented in whole or in part using technologies such as hyper-text mark-up language (HTML), Flash, Java, .net, web services, and rich site summary (RSS). In some implementations, a UI may be included in a stand-alone client (for example, thick client, fat client) configured to communicate (e.g., send or receive data) in accordance with one or more of the aspects described.

All references cited herein are incorporated herein by reference in their entirety. To the extent publications and patents or patent applications incorporated by reference contradict the disclosure contained in the specification, the specification is intended to supersede and/or take precedence over any such contradictory material.

The term “comprising” as used herein is synonymous with “including,” “containing,” or “characterized by,” and is inclusive or open-ended and does not exclude additional, unrecited elements or method steps.

What is claimed is:

1. A method for delivering items comprising:
identifying a geographic area;
receiving, in a processor, information regarding a plurality of resources in the identified geographic area;
receiving, in a processor, from a merchant via a user interface, a request for delivery of an item, the request comprising pick-up and delivery locations for the item;
determining, in a processor, whether the pick-up and delivery locations are within the identified geographic area;
determining, in a processor, a first delivery provider for picking up the item; and
instructing, via a mobile computing device, the first delivery provider regarding picking up the item.

2. The method of claim 1, further comprising:
determining, in a processor, a second delivery provider to receive the item from the first delivery provider;
determining, in a processor, a transfer point within the identified geographic area; and
instructing, via a mobile computing device, the second delivery provider to go to the transfer point.

3. The method of claim 2, wherein the first delivery provider travels a fixed route to the transfer point and the second delivery provider is diverted from a fixed route to travel to the transfer point.

4. The method of claim 1, the method further comprising, if the received pick-up location is not within the identified geographic area:
determining, in a processor, a location for pick-up of the item within the identified geographic area; and
instructing, via the user interface, the merchant regarding the location for pick-up within the identified geographic area.

5. The method of claim 4, wherein the request for delivery of an item comprises a request for delivery of a plurality of items.

6. The method of claim 5, wherein determining a location for pick-up of the item within the geographic area comprises:
determining a first portion of the plurality of items;
determining a second portion of the plurality of items;
determining a first location for pick-up of a first portion of the plurality of items;
determining a second location for pick-up of a second portion of the plurality of items; and
instructing, via the user interface, the merchant regarding the first and second pick-up locations for the items.

7. The method of claim 1, further comprising, providing, via the user interface, a computer readable code for the item.

8. The method of claim 7, further comprising, scanning, via a mobile computing device of the first delivery provider, the computer readable code on the item at the location for pick-up of the item.

9. A system for delivering items comprising:
a user interface for receiving, from a merchant via a user interface, a request for delivery of an item, the request comprising pick-up and delivery locations for the item;
a server storing information regarding a plurality of resources within a geographic area, wherein the server is configured to:
determine whether the pick-up and delivery locations are within the geographic area;
determine a first resource from the plurality of resources for picking up the item; and
instruct the first delivery provider regarding picking up the item.

10. The system of claim 9, wherein the server is further configured to:
determine a second resource from the plurality of resources to receive the item from the first resource;
determine a transfer point within the identified geographic area for transferring the item from the first resource to the second resource; and
send instructions to a mobile computing device of the second resource to go to the transfer point.

11. The system of claim 10, wherein the first resource travels a fixed route to the transfer point and the second resource is diverted from a fixed route to travel to the transfer point.

12. The system of claim 9, wherein, if the received pick-up location is not within the identified geographic area, the server is further configured to:
determine a location for pick-up of the item within the identified geographic area; and
instruct, via the user interface, the merchant regarding the determined location for pick-up within the identified geographic area.

13. The system of claim 12, wherein the server is configured to receive a request for of a plurality of items.

14. The system of claim 13, wherein the server is further configured to:
determine a first portion of the plurality of items;
determine a second portion of the plurality of items;
determine a first location for pick-up of a first portion of the plurality of items;
determine a second location for pick-up of a second portion of the plurality of items; and
instruct, via the user interface, the merchant regarding the first and second pick-up locations for the items.

15. The system of claim 14, wherein the server is further configured to determine the first portion and second portions of the plurality of items based on the received delivery points for the items.

16. The system of claim 9, wherein the server is further configured to provide to the merchant, via the user interface, a computer readable code for the item.

17. The system of claim 7, further comprising a scanning device configured to scan via the computer readable code on the item at the location for pick-up of the item.

18. A method of transporting items comprising:
storing, in a database, existing routes and schedules for a plurality of resources within a geographic area;
receiving, in a processor, a request for transportation of an item from a first location to a second location;
determining, in a processor, one of the plurality of resources which is traveling along a route that is within a threshold distance of the first location;
determining, in a processor, whether the determined one of the plurality of resources has capacity to receive the item; and
instructing, via a mobile computing device, the one of the plurality of delivery resources to travel to the first location.

19. The method of claim 18, further comprising, determining, in a processor, whether the one of the plurality of resources can meet delivery timing requirements for the item, and for a previously set schedule.

20. The method of claim 18, wherein the first location is a wholesaler and the second location is a retailer, and wherein the delivery resources belong to a distribution network.
